(19) United States
(12) Patent Application Publication
(10) Pub. No.: US 2009/0255389 A1
(43) Pub. Date: Oct. 15, 2009

(54) Lead cutter and method of cutting lead

(75) Inventor: Tooru Kumamoto, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/382,726

(22) Filed: Mar. 23, 2009

(30) Foreign Application Priority Data
Apr. 10, 2008 (JP) 2008-102637

(51) Int. Cl. B26D 3/00; B26D 7/10

(52) U.S. Cl. 83/35; 83/171

(57) ABSTRACT

There is provided a lead cutter that enables micro-adjusting a cutting clearance between a punch and a die with high accuracy. The lead cutter includes a die on which the lead provided in an encapsulating resin enclosing a semiconductor chip is to be placed, a punch that vertically moves relative to the die to thereby cut the lead, and a temperature controller that controls a temperature of at least one of the punch and the die, so as to adjust a clearance between the punch and the die.

This application is based on Japanese patent application No. 2008-102637, the content of which is incorporated hereinto by reference.

### BACKGROUND

1. Technical Field

The present invention relates to a lead cutter that cuts an outer lead provided in an encapsulating resin enclosing a semiconductor chip, and to a method of cutting the lead.

2. Related Art

To manufacture a semiconductor device with a plurality of outer leads (hereinafter simply lead, as the case may be) provided on two,or four sides of an encapsulating resin that encloses a semiconductor chip, the process typically includes mounting the semiconductor chip on a lead frame, encapsulating the semiconductor chip with the resin, removing fins of the encapsulating resin and executing solder plating, and then finishing the lead.

In the case of a surface mounting type semiconductor device, it is a common practice to bend the lead horizontally sticking out of the encapsulating resin perpendicularly downward and then horizontally outward, so as to form the lead in what is known as a gull wing shape.

The semiconductor device has to be made up in specified outer dimensions. A known process to do so includes, as shown in FIGS. 7A to 7C, cutting the lead in advance in a somewhat excessive length (FIG. 7A), bending the lead thus cut in a predetermined shape (FIG. 7B), and cutting the tip portion of the lead in the specified dimensions (FIG. 7C).

FIGS. 8A to 8C illustrate another known process, which include cutting the lead in advance in a predetermined length (FIGS. 8A to 8B), and shape the lead through a bending process in the specified dimensions (FIG. 8C).

Whichever process may be adopted, high accuracy and high reproducibility have to be secured with respect to the specified dimensions of the tip portion of the lead.

For cutting the lead, generally a lead cutter that severs the lead with a die and a punch is employed, from the viewpoint of the simplicity and durability of the mechanism, and high throughput thereby obtained.

Meanwhile, regarding the lead cutting process which determines the final outer shape of the semiconductor device, various improvements have lately been accomplished, primarily for the purpose of upgrading the reliability in implementing and bonding performance of the product. For example, JP-A No. H07-211838 teaches an optimal condition regarding the clearance between the die and the punch (hereinafter cutting clearance, as the case may be) which plays an important role for upgrading the reliability of the semiconductor device, in the lead cutting process.

The literature specifies the optimal condition of the cutting clearance between the die and the punch, for the purpose of properly forming solder drippings on the cut section of the lead that has been cut. To be more detailed, the cutting clearance is specified to be in a range of 14 to 21%, with respect to the entire thickness of the lead frame, including the lead and plated layers provided on the upper and lower sides thereof. According to the literature, severing the lead with the die and the punch located with the cutting clearance thus specified therebetween enables properly forming the solder drippings on the cut section of the lead, and thereby offers such advantages as reducing electrical resistance, upgrading the bonding strength, and preventing corrosion on the cut section.

[Patented document 1] JP-A No. H07-211838

In a latest lead cutting process of the semiconductor device, however, the process has come to be construed as a more quality-oriented process for minimizing implementation defect, which has to be executed under micronized conditions, rather than the process merely for cutting the lead. Accordingly, merely satisfying the cutting clearance specified in the patented document 1 (14 to 21% of the entire thickness of the lead frame) is often insufficient at present, in terms of the precision. Practically, in the above-specified range, the desired cutting clearance has to be adjusted with an accuracy of within approx. 1% of the entire thickness of the lead frame.

Moreover, the material thickness of the lead frame for the current semiconductor device has been generally reduced to 0.125 to 0.150 mm. Even taking into consideration the thickness of the plated layer of palladium, solder or the like provided on the upper and lower surface of the lead, the entire thickness of the lead frame can only be as thin as approx. 0.125 to 0.170 mm.

In the current lead cutting process, therefore, the cutting clearance has to be micro-adjusted with such high accuracy as approx. 1.25 μm or less, which corresponds to 1% of 0.125 mm, the entire thickness of the lead frame.

The present invention has been accomplished in view of the foregoing problem, and provides a lead cutter that allows micro-adjusting a cutting clearance between a punch and a die with a high accuracy, and a method of thus cutting the lead.

### SUMMARY

In one embodiment, there is provided a lead cutter comprising:

a die on which an outer lead provided in an encapsulating resin enclosing a semiconductor chip is to be placed;

a punch that vertically moves relative to the die to thereby cut the outer lead; and

a temperature controller that controls a temperature of at least one of the punch and the die, so as to adjust a clearance between the punch and the die.

In the present invention, the term of “vertically” defining the movement of the punch with respect to the die does not always mean the vertical direction according to the gravity. Also, the “vertically” does not always mean the upward or downward direction along the normal of the die plane on which the outer lead is placed.

In another embodiment, there is provided a method of cutting a lead that employs a punch and a die to cut an outer lead provided in an encapsulating resin enclosing a semiconductor chip, comprising:

cutting the outer lead upon controlling a temperature of at least one of the punch and the die, thereby adjusting a clearance between the punch and the die.

With the lead cutter and the method thus arranged, the temperature of either or both of the punch and the die can be controlled to thereby cause thermal expansion or thermal contraction, so as to micro-adjust the cutting clearance. Such micro-adjustment of the cutting clearance is achieved by the combination of the linear expansion coefficient of the punch and/or the die, the dimensions thereof in a widthwise direction of the clearance, and the accuracy of the temperature control, which offers by far higher accuracy of adjustment than that achieved by a mechanical method such as employing a pressing screw or a shim spacer.

Therefore, employing the present invention for cutting the lead having a plated layer on the upper and lower surface enables properly forming the solder drippings on the cut section.

It is to be noted that the constituents of the present invention do not necessarily have to be individually independent, but may be configured such that a plurality of constituents constitutes a single member, that a constituent is composed of a plurality of members, that a constituent is a part of another constituent, that a part of a constituent and a part of another constituent overlap, and so forth.

Although a plurality of steps may be sequentially described in the description of the lead cutting method according to the present invention, such sequence does not necessarily limit the order in practically executing those steps, unless so expressed. Further, the plurality of steps does not have to be individually executed at different timings unless so expressed, but may be arranged such that one of the steps is executed during the execution of another, that the execution timing of a step partially or entirely overlap that of another, and so forth.

With the lead cutter and the method of cutting a lead according the present invention, controlling the temperature of at least one of the punch and the die allows controlling the thermal distortion thereof as desired, and thereby micro-adjusting the clearance between the punch and the die (cutting clearance) with high accuracy.

Also, controlling the temperature of the punch and/or the die suppresses fluctuation in cutting clearance during the lead cutting process, thereby achieving high reproducibility of the length of the cut leads.

### BRIEF DESCRIPTION OF THE DRAWINGS

The above and other objects, advantages and features of the present invention will be more apparent from the following description taken in conjunction with the accompanying drawings, in which:

FIG. 1A is a schematic side view showing a lead cutter according to a first embodiment of the present invention, and FIG. 1B is a schematic plan view of a lower die device constituting the lead cutter;

FIG. 2 is a schematic vertical cross-sectional view showing a function execution unit of the lead cutter according to the first embodiment;

FIG. 3 is a schematic plan view showing the function execution unit of the lead cutter according to the first embodiment;

FIG. 4 is a schematic vertical cross-sectional view showing the function execution unit of the lead cutter according to the first embodiment;

FIG. 5A is a schematic plan view showing a semiconductor chip having the leads to be cut by a lead cutting method according to the first embodiment, and FIG. 5B is a cross-sectional view taken along a line B-B in FIG. 5A;

FIG. 6 is a schematic vertical cross-sectional view showing a function execution unit of the lead cutter according to a second embodiment;

FIGS. 7A to 7C are side views of a lead for explaining a lead cutting method; and

FIGS. 8A to 8C are side views of a lead for explaining another lead cutting method.

### DETAILED DESCRIPTION

The present invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereunder, embodiments of the present invention will be described referring to the drawings. In all the drawings, same or similar constituents are given the same numeral, and the description thereof will not be repeated.

### First Embodiment

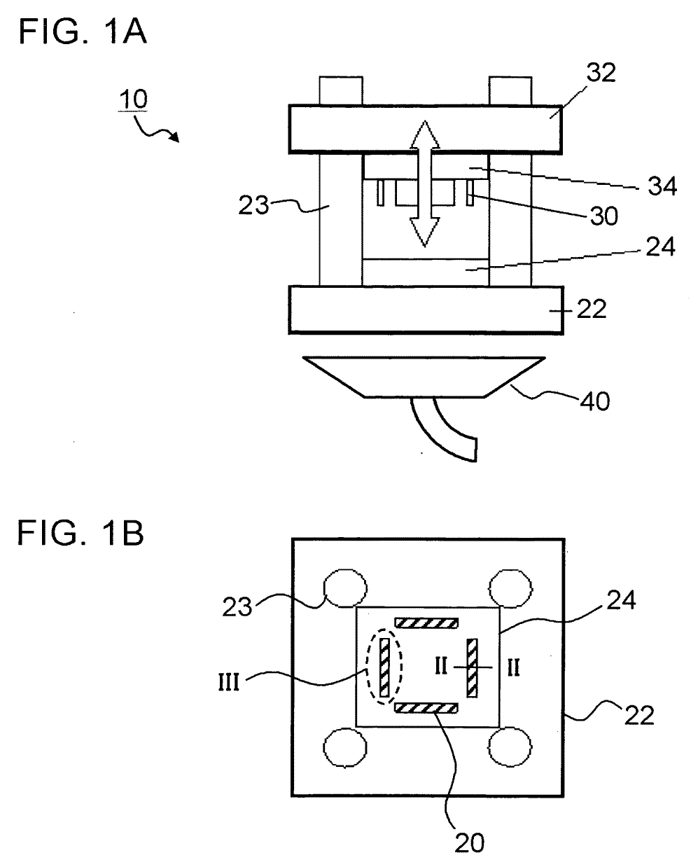

FIG. 1A is a schematic side view showing a lead cutter according to this embodiment, and FIG. 1B is a schematic plan view of a lower die device constituting the lead cutter.

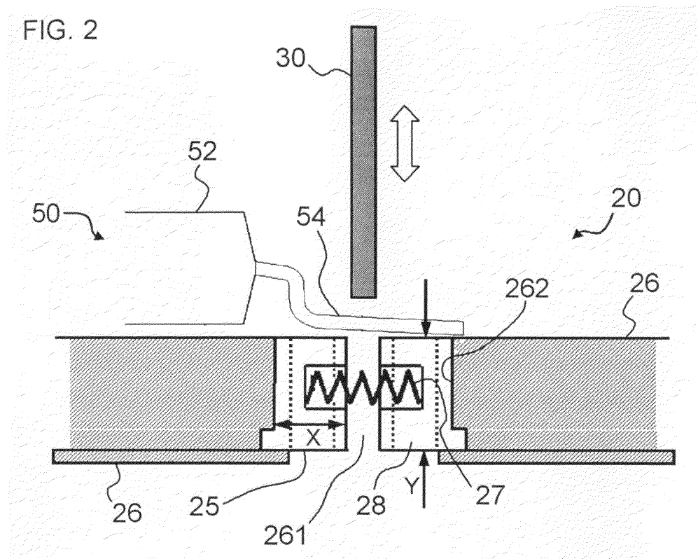

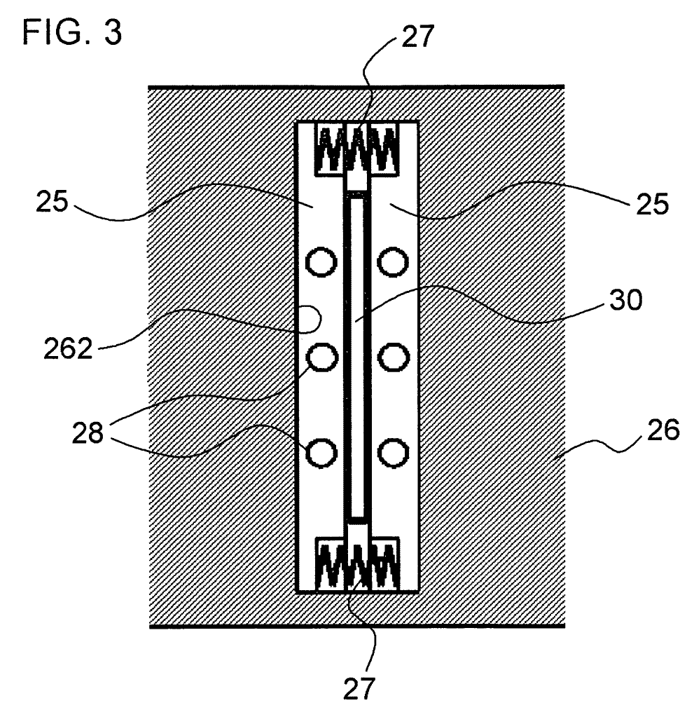

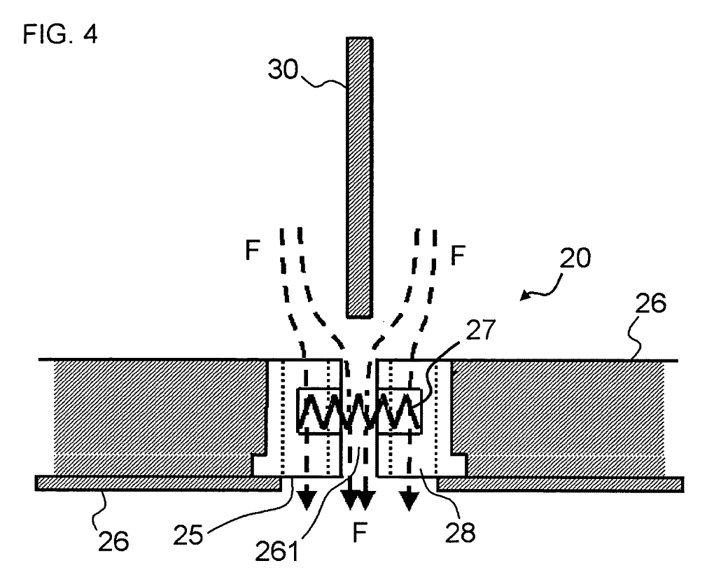

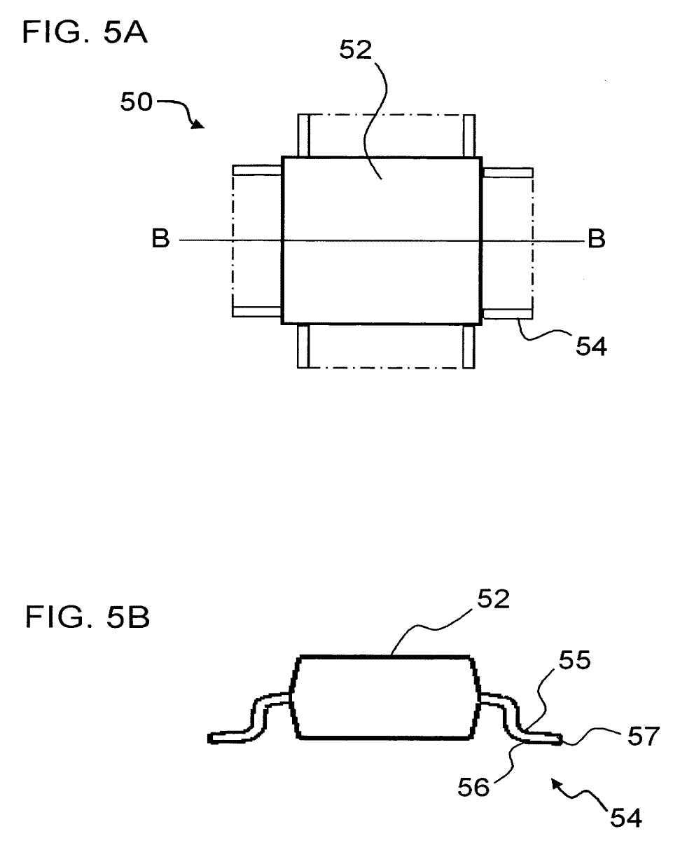

FIG. 2 is a schematic vertical cross-sectional view showing a punch and a die (hereunder, the combination of the punch and the die will be referred to as function execution unit, as the case may be) of the lead cutter according to this embodiment, and corresponds to a cross-sectional view taken along a line II-II in FIG. 1B. FIG. 3 is a schematic plan view of the function execution unit, and corresponds to a region III surrounded by broken lines in FIG. 1B. FIG. 4 is a schematic vertical cross-sectional view showing the function execution unit under a state where a ventilator is activated. FIG. 5A is a schematic plan view showing a semiconductor chip having the leads to be cut by a lead cutting method according to the first embodiment, and FIG. 5B is a cross-sectional view taken along a line B-B in FIG. 5A.

To start with, the outline of the lead cutter according to this embodiment will be described.

The lead cutter 10 includes a die 20 on which a lead 54 provided in an encapsulating resin 52 enclosing a semiconductor chip (not shown) is placed, and a punch 30 that moves vertically with respect to the die 20, to thereby cut the lead 54.

The lead cutter 10 also includes a temperature controller that controls the temperature of at least one of the punch 30 and the die 20, thereby adjusting the cutting clearance between the punch 30 and the die 20.

The lead cutting method according to this embodiment employs the punch 30 and the die 20 for cutting the lead 54 provided in the encapsulating resin 52 enclosing the semiconductor chip (not shown), and includes controlling the temperature of at least one of the punch 30 and the die 20 to thereby adjust the cutting clearance between the punch 30 and the die 20, and cutting the lead 54 upon adjusting the cutting clearance.

Detailed description will now be given on the lead cutter 10 according to this embodiment, and a semiconductor device 50 having a lead to be cut by the lead cutter 10.

[Semiconductor Device]

The semiconductor device 50 shown in FIGS. 5A and 5B is enclosed in an encapsulating resin 52 of a rectangular shape in a plan view, and provided with a plurality of leads 54 horizontally sticking out of the respective lateral faces of the encapsulating resin 52. FIG. 5A excludes some of the leads 54, except for those located at the respective ends of the lateral faces.

The material thickness of the lead 54 is 0.125 to 0.150 mm, and the width thereof (in a plan view) is approx. 0.2 mm.

The semiconductor device 50 having the lead 54 to be cut according to this embodiment is of what is known as a QFP type, having the encapsulating resin 52a of a rectangular shape for enclosing the semiconductor chip, with the leads 54 sticking out of the four peripheral sides. This embodiment is also applicable to the semiconductor device 50 of so-called an SOP type, having the leads 54 sticking out of two opposing sides.

The upper surface 55, the lower surface 56 and the lateral surface 57 of the lead 54 are plated with solder. The semiconductor device 50 is formed into what is known as a gull wing shape of predetermined outer dimensions as shown in FIG. 5B, through a lead cutting process of isolating the lead 54 from the lead frame, a bending process of forming the lead 54 into a predetermined shape and so on.

It is to be noted, however, that the lead cutter 10 and the lead cutting method according to the present invention are intended for cutting the lead 54 in a predetermined length with high accuracy, and the lead may be bent in any desired shape.

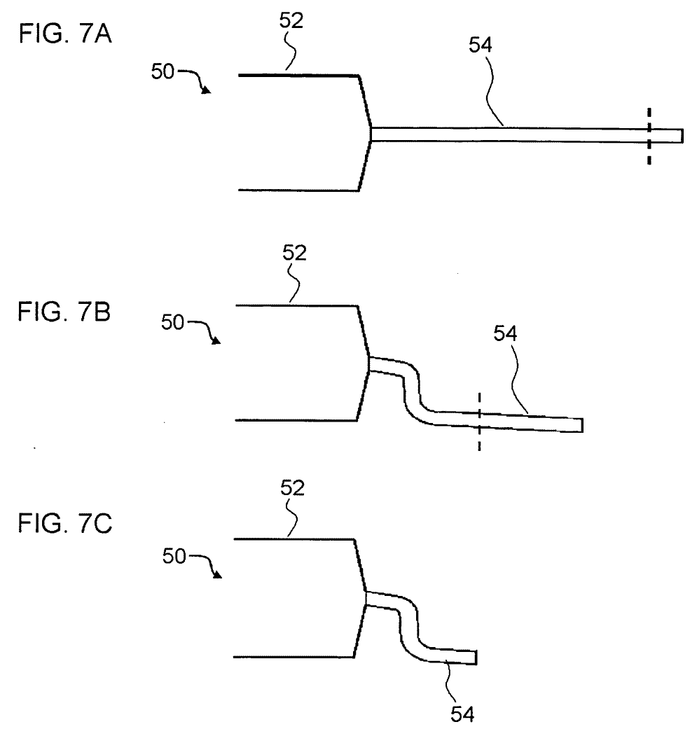

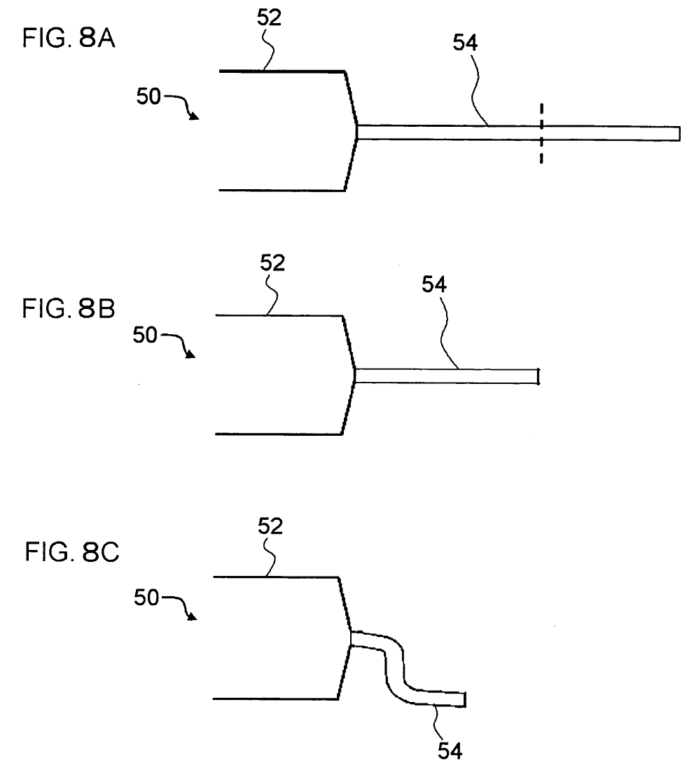

The tip portion cutting process, for cutting the tip portion of the lead 54 in a specified length, is executed before or after the bending process of the lead 54, as described referring to FIGS. 7A through 8C. The lead cutter 10 and the lead cutting method according to this embodiment may be employed either before or after the bending process of the lead 54.

[Lead Cutter]

The lead cutter 10 according to this embodiment shown in FIG. 1A includes an upper die device 32 and a lower die device 22, connected through a slide shaft 23 so as to vertically slide (as indicated by a blank arrow) relative to each other. On an upper surface of the lower die device 22 a lower base 24 is provided, while on a lower surface of the upper die device 32 an upper base 34 is provided so as to oppose the lower base 24.

To the upper base 34, the punch 30 for punching the lead 54 is attached so as to project downward. The upper base 34 is of a rectangular shape, and one punch 30 is provided so as to project from each of the four sides, i.e. totally four punches 30 are provided.

As shown in FIG. 1B, on the upper surface of the lower base 24 the die 20 is mounted, for placing the lead 54 thereon.

The upper die device 32 is caused to move up and down by a force of a press machine (not shown), so that the punch 30 severs the lead 54 placed on the die 20. A blank arrow in FIG. 2 indicates how the punch 30 moves up and down.

The die 20 of this embodiment is constituted of a combination of a blade portion 25 and a base table 26.

The blade portion 25 is made of a metal material including tool steels such as carbon steel, super steel, and an alloy tool steel (SKD steel). These have a relatively high linear expansion coefficient, for example approx. 10×10⁻⁶[/K].

The dimensions of the blade portion 25 is not specifically limited, however the width thereof (left-to-right direction in FIGS. 2 and 3) is normally approx. 1 to 20 mm.

The base table 26 may be constituted of a metal, a resin or a ceramic material having a lower linear expansion coefficient than that of the blade portion 25. Employing such materials that are largely different in linear expansion coefficient for the blade portion 25 and the base table 26 allows thermally deforming the blade portion 25 only, when controlling the temperature of the die 20 as will be described later.

As shown in FIGS. 2 and 3, the die 20 according to this embodiment includes a pair of blade portions 25 located so as to oppose each other across the punch 30, and an elastic member, for example a spring 27, which biases the blade portions 25 so as to move away from each other (left-to-right direction in FIGS. 2 and 3).

The spring 27 is located at the respective longitudinal (up and down direction in FIGS. 2 and 3) end portions of the pair of blade portions 25, to thereby avoid interference with the punch 30 moving between the blade portions 25.

The blade portion 25 and the base table 26 are stacked in a horizontal direction, in other words along the extending direction of the lead 54 placed on the die 20. Here, in FIG. 3 the portion corresponding to the base table 26 is hatched, for the sake of visual explicitness.

The base table 26 is formed in an integral body, and includes four mounting orifices 261 right under the punch 30. Inside each mounting orifice 261, the pair of blade portions 25 is respectively mounted so as to be butted to the inner wall (abutment surface 262) of the orifice 261. With such structure, the spring 27 presses the blade portions 25 against the respective abutment surfaces 262, so that when the blade portion 25 is thermally expanded or thermally contracted by the temperature controller to be described later, the blade portion 25 expands or shrinks with respect to the abutment surface 262, thereby changing the cutting clearance.

Also, as shown in FIG. 2, when the lead 54 of the semiconductor device 50 is about to be cut, a part or the whole of the encapsulating resin 52 is placed on the base table 26, and the lead 54 is placed on the blade portion 25. Here, a part of the encapsulating resin 52 may be placed on the blade portion 25.

The clearance between the opposing blade portions 25 is open throughout the thickness of the base table 26, and hence the segment of the lead 54 cut away by the punch 30 can freely fall toward the lower surface side of the base table 26.

The lead cutter 10 according to this embodiment includes a pair each of blade portions 25, right under each of the four punches 30 located so as to form a square shape along each side of the upper base 34. Such structure allows cutting the leads 54 sticking out of the four sides at maximum of the encapsulating resin 52, at a time. In the case where the leads 54 are provided on two opposing sides of the encapsulating resin 52, two opposing punches 30 out of the four can be employed for cutting the leads 54 on the two sides at a time.

Also, the lead cutter 10 may be employed for cutting the leads 54 sticking out of one or more sides of a single encapsulating resin 52, or for cutting the leads 54 sticking out of each side of a set of four encapsulating resins 52, at a time.

The lead cutter 10 according to this embodiment includes, as a remedy for inhibiting cut chippings from flying upward, a ventilator 40 that aspirates a gaseous fluid F to thereby collect the cut chippings of the lead 54. The ventilator 40 is located below the lower die device 22, and aspirates the gaseous fluid F provided around the lead cutter 10 in a direction from the punch 30 toward the die 20, to thereby collect the chippings from the upper surface of the base table 26 through a ventilation hole 28, thus preventing the chippings from contacting the semiconductor device 50.

[Temperature Controller]

The lead cutter 10 according to this embodiment includes the temperature controller that heats or cools the blade portion 25, so that the blade portion 25 expands or contracts in the widthwise direction of the clearance for the punch 30 to intrude. Accordingly, the cutting clearance can be micro-adjusted in the order of the thermal deformation of the blade portion 25 in the widthwise direction of the clearance.

Thus, the lead cutting method according to this embodiment also involves aspirating the gaseous fluid F to thereby collect the cut chippings of the lead 54, as well as controlling the temperature of the punch 30 and the die 20 through heat exchange with the gaseous fluid F that has been aspirated.

Here, the widthwise direction of the clearance of the lead cutter 10 according to this embodiment corresponds to the thicknesswise direction of the punch 30.

The temperature controller may be constituted in various manners. The lead cutter 10 according to this embodiment adopts the system of bringing the flowing gaseous fluid F and the blade portion 25 into mutual contact, for the heat exchange therebetween.

To be more detailed, the blade portion 25 is provided with the ventilation hole 28 as shown in FIG. 4, and the ventilator 40 serving as the temperature controller causes the gaseous fluid F to flow through the ventilation hole 28, so as to control the temperature of the blade portion 25.

In other words, the lead cutter 10 according to this embodiment heats or cools the blade portion 25 through heat transfer from and to the gaseous fluid F aspirated by the ventilator 40, which also serves to collect the cut chippings of the lead 54, so as to thermally deform the blade portion 25 as desired, thereby adjusting the cutting clearance.

In the case of, for example, repeating the cutting process of the lead 54 with the lead cutter 10 installed in a room temperature atmosphere, the temperature of the blade portion 25 is stabilized at a temperature higher than the room temperature. The frictional heat generated upon severing the lead 54 is given to the punch 30 and the blade portion 25, and hence the blade portion 25 reaches a predetermined equilibrium temperature higher than the room temperature, through heat exchange with the atmosphere of the room temperature.

Accordingly, the equilibrium temperature of the blade portion 25 can be raised or lowered, by shifting the balance of the heat exchange.

Specifically, it is appropriate to control the flow rate of the gaseous fluid F so as to change the amount of the gaseous fluid F that contacts the blade portion 25 per unit time. Increasing such flow rate causes the equilibrium temperature of the blade portion 25 to be closer to the room temperature.

Also, the lead cutter 10 according to this embodiment may include a heater that heats the atmosphere on the upstream side of the blade portion 25, to make the temperature of the blade portion 25 higher than the room temperature by aspirating the heated gaseous fluid F with the ventilator 40 to thereby blow the gaseous fluid F toward the blade portion 25.

In addition, the present invention also includes employing an electric heating wire buried inside the blade portion 25 as the temperature controller so as to generate Joule heat upon supplying power, and, as will be described later, irradiating the blade portion 25 finished in black with light to thereby heat the blade portion 25 with radiant heat. Also, such methods may be employed in combination.

In the lead cutter 10 according to this embodiment, since the gaseous fluid F is constantly flowing through the function execution unit, the temperature of the die 20 and the punch 30 is maintained at a constant level, and therefore the cutting clearance is also maintained constant, which facilitates achieving high reproducibility in the lead cutting performance.

The ventilator 40 may be constituted of a popular fan or blower. The ventilation hole 28 is provided, as shown in FIGS. 2 and 3, in a plurality of positions aligned longitudinally of the blade portion 25, and formed so as to penetrate therethrough in a thicknesswise direction. Accordingly, as shown in FIG. 4 the gaseous fluid F flows through the ventilation holes 28, as well as through between the opposing blade portions 25 in the mounting orifice 261, thus performing heat exchange with the blade portion 25.

In this embodiment, in order to adjust the cutting clearance with high accuracy, the following items are adopted as parameters for controlling the temperature of the blade portion 25 [symbol] temperature.

(a) Linear expansion coefficient of the metal material constituting the blade portion 25

(b) Width X of the blade portion 25 in a widthwise direction of the clearance (Ref. FIG. 2)

(c) Aspiration amount of the gaseous fluid F by the ventilator 40 per unit time

(d) Flow speed and flow rate of the gaseous fluid F through the ventilation hole 28

(e) Contact area between the ventilation hole 28 and the gaseous fluid F, which depends on the thickness Y of the blade portion 25 (Ref. FIG. 2)

The items (a) and (b) are primary parameters that determine the position of the front edge of the blade portion 25 for cutting the lead 54. The item (c) is a secondary parameter employed to control the temperature for cooling the die 20. The items (d) and (e) are tertiary parameters for further improving the heat transfer efficiency for cooling the blade portion 25.

Utilizing the foregoing parameters, the cooling efficiency by the gaseous fluid F flowing through inside of the blade portion 25 and along the lateral face thereof can be controlled, to thereby adjust the cutting clearance as desired. With the lead cutter 10 according to this embodiment, the cutting clearance can be adjusted in an increment of 0.1 μm through adjusting those parameters.

Specifically, the parameters (a) to (e) can be adjusted as follows.

The parameter (a) becomes adjustable by designing the blade portion 25 attached to the mounting orifice 261 of the base table 26, as a removable component. In this case, a plurality of blade portions 25 constituted of a material of a different linear expansion coefficient may be prepared in advance, so that the blade portion of the suitable material is selectively attached to the mounting orifice 261, according to the entire thickness of the lead 54 and the thickness of the plated layer.

Regarding the parameters (b) and (e), the die 20 may be made compatible with a plurality of blade portions 25 of different dimensions in width and/or thickness. In this case, as in the case of (a) above, one of the blade portions 25 of different widths and thicknesses, which are to be removably mounted on the base table 26 of the die 20, may be appropriately selected and attached to the mounting orifice 261.

The parameter (c) can be increased or decreased by controlling the output of the ventilator 40.

To adjust the parameter (d), a flow controller that adjusts the flow rate of the gaseous fluid F may be provided in the lead cutter 10. The flow controller may be realized in various manners. For example, an aperture controller may be provided on one of the upper surface side, inside, and lower surface side of the mounting orifice 261, so as to increase and decrease the aperture area thereof. Also, a block plate may be erected above the die 20 at a position where the punch 30 and the semiconductor device 50 are exempted from interference, to thereby adjust the flow rate of the gaseous fluid F flowing toward the mounting orifice 261.

The foregoing embodiment offers the following advantageous effects.

The lead cutter 10 according to this embodiment includes a temperature controller that controls the temperature of at least one of the punch 30 and the die 20, to thereby adjust the cutting clearance.

The lead cutting method according to this embodiment includes cutting the lead 54 upon controlling the temperature of at least one of the punch 30 and the die 20, thereby adjusting a clearance therebetween.

With the cutter and the method according to this embodiment, therefore, the punch 30 and the die 20 can be thermally expanded or thermally contracted, so as to micro-adjust the cutting clearance, in the lead cutting process of cutting the lead 54 in a desired length.

Accordingly, in the case where the optimal cutting clearance for the lead 54 to be cut is known, the target cutting clearance can be set with high accuracy.

Also, the lead cutter 10 according to this embodiment enables micro-adjusting the cutting clearance. Therefore, although the optimal cutting clearance for the lead 54 to be cut is unknown yet, the temperature of the die 20 and the punch 30 can be raised or lowered for adjusting the cutting clearance, to thereby determine the optimal value.

The lead cutter 10 according to this embodiment eliminates the need to employ a spacer or the like, for adjusting the edge position of the punch 30 and the die 20, which determines the cutting clearance. Also, though the punch 30 and/or the die 20 are replaced with a new one, it is not necessary to mechanically adjust the edge position each time.

Accordingly, the foregoing embodiment allows easily adjusting the cutting clearance, without the trouble of performing positional adjustment. Besides, the cutting clearance can be micro-adjusted by a proper combination of selected materials and dimensions of the punch 30 and the die 20.

Although the temperature around the punch 30 and the die 20 is generally prone to fluctuate depending on the working condition of the equipment in which the lead cutter is incorporated, the lead cutter 10 according to this embodiment constantly adjusts the temperature of the punch 30 and the die 20, thereby stabilizing the condition under which the cutting process is executed.

Thus, the lead cutter 10 according to this embodiment enables reducing the number of work steps and the work set-up time by eliminating troublesome jobs such as adjustment of die devices, and also reducing the cost mainly because of saving expensive tools for adjusting the die devices. The lead cutter 10 further provides a highly accurate die adjusting performance as a lead cutting die device, thereby contributing to stabilization of the product quality and upgrading the reliability thereof.

The lead cutter 10 according to this embodiment includes the combination of the blade portion 25 on which the lead 54 is placed, and the base table 26 on which the encapsulating resin 52 is placed, and the latter has a lower linear expansion coefficient than the former. Upon heating or cooling the blade portion 25 by the temperature controller, the blade portion 25 expands or shrinks from or toward the punch 30, in a widthwise direction of the clearance. In this process, the thermal distortion of the blade portion 25 on which the lead 54 is placed is predominant compared with the thermal distortion of the base table 26 on which the encapsulating resin 52 is placed. Accordingly, when the blade portion 25 is thermally expanded or thermally contracted as specified, the encapsulating resin 52 is prevented from shifting the position by following up the movement of the blade portion 25, and therefore the lead 54 can be cut in an accurate length as desired.

In the lead cutter 10 according to this embodiment, the blade portion 25 includes the ventilation holes 28. Also, the temperature controller includes the ventilator 40 that causes the gaseous fluid F serving to adjust the temperature of the blade portion 25 to flow through the ventilation holes 28. Such structure provides a larger contact area between the blade portion 25 and the gaseous fluid F to thereby increasing the heat exchange efficiency, and consequently upgrades the temperature control efficiency of the blade portion 25.

The lead cutter 10 according to this embodiment also includes the flow controller that controls the flow rate of the gaseous fluid F flowing through the ventilation holes 28. Controlling thus the flow rate leads to an increase or decrease in heat exchange efficiency between the blade portion 25 and the gaseous fluid F, and hence contributes to upgrading the accuracy in temperature control of the blade portion 25.

In the lead cutter 10 according to this embodiment, the die 20 includes the aperture controller that expands or reduces the aperture area of the ventilation holes 28. Such structure makes the aperture area of the ventilation holes 28 variable, thereby enabling controlling the heat exchange efficiency between the blade portion 25 and the gaseous fluid F and thus adjusting the temperature of the blade portion 25 accurately as specified.

In the lead cutter 10 according to this embodiment, since the ventilator 40 aspirates the gaseous fluid F, the cut chippings of the lead 54 can be collected. Also, the lead cutting method according to this embodiment includes controlling the temperature of the punch 30 and the die 20 through heat exchange with the gaseous fluid F aspirated. Thus, the cutter and the method according to this embodiment utilizes the gaseous fluid F, initially employed for collecting the cut chippings, for also controlling the temperature of the blade portion 25. Accordingly, in the case where the lead cutter already includes a chipping collection mechanism, the gaseous fluid F to be aspirated can be employed for controlling the temperature of the blade portion 25, without the need to additionally installing a device for cooling the blade portion 25.

In the lead cutter 10 according to this embodiment, the blade portion 25 is removably mounted on the die 20, and the die 20 is compatible with a plurality of blade portions 25 of different widths and thicknesses. Such structure allows properly selecting the blade portion 25 having the suitable width and thickness. A wider blade portion 25 thermally deforms by a larger amount in the widthwise direction of the clearance, by temperature fluctuation. A thicker blade portion 25 provides a larger contact area with the gaseous fluid F, and has larger heat capacity, and hence incurs smaller fluctuation in temperature during the lead cutting process, thereby offering high reproducibility of the cutting results. On the contrary, a thinner blade portion 25 quickly changes its temperature upon contacting the gaseous fluid F, thereby facilitating quickly starting up the lead cutting process.

In the lead cutter 10 according to this embodiment, the die 20 includes a pair of blade portions 25 opposing each other across the pinch 30, and the elastic member biasing the blade portions 25 so as to move away from each other. Such structure keeps the blade portion 25 and the base table 26 from separating from each other even though the die 20 is cooled and thermally contracted, so that the blade portion 25 is constantly pressed against the base table 26 even during the thermal deformation. Accordingly, the fluctuation in dimensions of the blade portion 25 by the thermal expansion or contraction is directly reflected in the increase or decrease in the cutting clearance, and therefore the cutting clearance can be accurately adjusted.

The lead cutter 10 according to this embodiment allows adjusting the cutting clearance for the punch 30 and the die 20 in an increment of 0.1 μm. This can be understood from the following calculation. Assuming that the blade portion 25 is constituted of a carbon steel (linear expansion coefficient: 10×10⁻⁶/K) and has a width of 10 mm in the widthwise direction of the clearance, when the temperature of the blade portion 25 is fluctuated by 1K, the fluctuation of the cutting clearance is worked out as 10⁻⁴ mm, which is 0.1 μM. The lead cutter 10 offers, therefore, sufficient adjusting capability that satisfies the adjustment accuracy of 1 μm or less, currently required with respect to the cutting clearance.

It is to be noted that the present invention is not limited to the foregoing embodiment, but includes various modifications and improvements as far as the object of the present invention is fulfilled.

### Second Embodiment

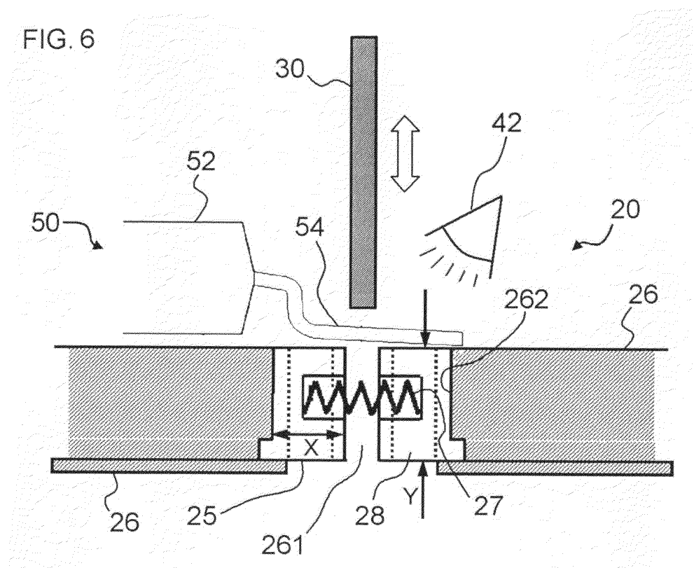

FIG. 6 is a schematic vertical cross-sectional view showing a function execution unit of the lead cutter 10 according to this embodiment. In the lead cutter 10 according to this embodiment, the blade portion 25 is finished in black, and the temperature controller includes a light source 42 that emits light to the blade portion 25. Increasing and decreasing the quantity of light emitted by the light source 42 enables controlling the amount of radiation heating of the blade portion 25. Thus, the temperature of the blade portion 25 can be controlled, to thereby adjust the cutting clearance as desired.

The light source 42 may be constituted of an illuminator that emits visible light or infrared ray, or an LED.

The lead cutter 10 according to this embodiment may include both of the light source 42 and the ventilator 40. In this case, the heating by the light source 42 and the cooling by the ventilator 40 can be executed as desired. Therefore, the selection range of the temperature setting for the blade portion 25 can be extended, and the adjustment accuracy can also be upgraded.

Meanwhile, although the lead cutter 10 according to the preceding embodiment includes the ventilator 40 that cools toward the room temperature the blade portion 25 being heated by the frictional heat generated upon cutting the lead 54, that lead cutter 10 is not provided with a heater that heats the blade portion 25. Accordingly, the temperature adjustment range of the blade portion 25 corresponds to a differential value between the equilibrium temperature under the state where the ventilator 40 is stopped thus to make the flow rate of the gaseous fluid F zero, and the equilibrium temperature under the state where the ventilator 40 is outputting the maximum power.

On the other hand, the lead cutter 10 according to this embodiment includes the light source 42 to heat the blade portion 25, and hence allows setting the maximum temperature of the blade portion 25 at a higher level than with the lead cutter 10 of the foregoing embodiment. Thus, the temperature adjustment range of the blade portion 25 can be extended, and hence the adjustment range of the cutting clearance can also be increased.

Also, the punch 30 may be finished in black, so as to control the temperature thereof by emitting light thereto. More specifically, raising the temperature of the punch 30 so as to thermally expand in the widthwise direction of the clearance results in a decrease in cutting clearance. In this case, it is appropriate to employ a metal material having a relatively high linear expansion coefficient for the punch 30. In this embodiment, accordingly, the temperature of either or both of the blade portion 25 and the punch 30 can be controlled.

The adjustment range of the temperature of the punch 30 and the blade portion 25 may be set, for example, as 5 to 35° C.

Since the punch 30 is normally of a plate shape, in case that the punch 30 is warped by thermal expansion, such disadvantage may be incurred that the cut lengths of the leads 54 simultaneously cut by the punch 30 become uneven. From such viewpoint, it is preferable to finish the punch 30 in a mirror surface whenever possible, and to finish the blade portion 25 in black by a surface treatment, coating, or the like.

In the lead cutter 10 according to this embodiment, the temperature controller may press the gaseous fluid forward, instead of aspirating. For example, a blower may be installed above the punch 30, to thereby blow the gaseous fluid F toward the punch 30 and the die 20. In this case, a heat source may be provided to the blower, to heat the gaseous fluid F to thereby produce a flow bearing higher enthalpy than the atmospheric air (heated flow), to be blown toward the punch 30 and the die 20. Such arrangement enables raising the maximum temperature of the die 20 and the punch 30 to a higher level than with the lead cutter of the preceding embodiment, thereby extending the adjustment range of the cutting clearance.

Also, for improving the controlling efficiency of the temperature of the punch 30, one or more ventilation holes may be provided in the upper base 34 and the upper die device 32, to thereby improve the contact efficiency between the heated flow and the punch 30.

### Third Embodiment

In the lead cutter 10 according to this embodiment, the temperature control of the punch 30 and the die 20 is automatically executed by the temperature controller, so that the cutting clearance specified by the user is accurately achieved.

Specifically, the lead cutter 10 according to this embodiment stores a memory of the output of the ventilator 40 and the cutting clearance attained when the die 20 and the punch 30 have reached the equilibrium temperature, in association therebetween. Also, the lead cutter 10 includes an output controller that increases and decreases the output of the ventilator 40 such that the cutting clearance specified by the user is achieved.

The output of the ventilator 40 and the corresponding cutting clearance are stored in a storage unit of the lead cutter 10, in a form of calibration curve, a table, or a function.

The lead cutter 10 according to this embodiment controls the temperature of the die 20 and the punch 30 by the output controller, according to the type of the semiconductor device 50 to undergo the lead cutting process, in particular the entire thickness of the lead 54 and the thickness of the plated layer. Such arrangement enables achieving an accurate cutting clearance.

Further, the lead cutter 10 according to this embodiment may store a memory of aperture area of the ventilation hole 28 and the cutting clearance in association therebetween, upon fixing the output of the ventilator 40 and making the aperture area of the ventilation hole 28 variable. In this case, the aperture controller increases and decreases the aperture area of the ventilation holes 28, so as to achieve the desired cutting clearance.

It is apparent that the present invention is not limited to the above embodiments, and may be modified and changed without departing from the scope and spirit of the invention.

What is claimed is:

1. A lead cutter comprising:
a die on which an outer lead provided in an encapsulating resin enclosing a semiconductor chip is to be placed;
a punch that vertically moves relative to said die to thereby cut said outer lead; and
a temperature controller that controls a temperature of at least one of said punch and said die, so as to adjust a clearance between said punch and said die.

2. The lead cutter according to claim 1,
wherein said die includes a blade portion on which said outer lead is placed and a base table having a lower linear expansion coefficient than that of said blade portion, and on which said encapsulating resin is placed; and
said temperature controller heats or cools said blade portion, so that said blade portion expands or contracts in a direction toward said punch across said clearance.

3. The lead cutter according to claim 2,
wherein said blade portion includes a ventilation hole; and
said temperature controller further includes a ventilator that causes a gaseous fluid that controls a temperature of said blade portion to flow through said ventilation hole.

4. The lead cutter according to claim 3, further comprising:
a flow controller that controls a flow rate of said gaseous fluid flowing through said ventilation hole.

5. The lead cutter according to claim 3,
wherein said die includes an aperture controller that increases and decreases an aperture area of said ventilation hole.

6. The lead cutter according to claim 3,
wherein said ventilator aspirates said gaseous fluid, to thereby collecting cut chippings of said outer lead which has been cut.

7. The lead cutter according to claim 2,
wherein said blade portion is black; and
said temperature controller includes a light source that emits light to said blade portion.

8. The lead cutter according to claim 2,
wherein said blade portion is removably mounted on said die; and
said die is compatible with a plurality of said blade portions each having a different dimension in a direction toward said punch across said clearance, or in a vertical direction.

9. The lead cutter according to claim 2,
wherein said die includes a pair of said blade portions located so as to oppose each other across said punch, and an elastic member biasing said blade portions so as to move away from each other.

10. The lead cutter according to claim 1,
wherein said clearance between said punch and said die is adjustable in an increment of 0.1 μm.

11. A method of cutting a lead that employs a punch and a die to cut an outer lead provided in an encapsulating resin enclosing a semiconductor chip, comprising:
cutting said outer lead upon controlling a temperature of at least one of said punch and said die, thereby adjusting a clearance between said punch and said die.

12. The method according to claim 11, further comprising:
collecting cut chippings of said outer lead by aspirating a gaseous fluid;
wherein said controlling a temperature includes causing heat exchange between said gaseous fluid aspirated and at least one of said punch and said die.
